(19) United States
(12) Patent Application Publication
(10) Pub. No.: US 2019/0078643 A1
(43) Pub. Date: Mar. 14, 2019

(54) USER-TUNED, ACTIVE VIBRATION-ISOLATION SYSTEM

(71) Applicant: Technical Manufacturing Corporation, Peabody, MA (US)

(72) Inventors: Emil Kraner, Swampscott, MA (US); Steven T. RYAN, Newburyport, MA (US); John E. BOOTH, Newbury, MA (US); Jeffrey L. WORTHEY, Waltham, MA (US)

(73) Assignee: Technical Manufacturing Corporation, Peabody, MA (US)

(21) Appl. No.: 16/084,772

(22) PCT Filed: Mar. 15, 2017
(86) PCT No.: PCT/US2017/022532

§ 371 Date: Sep. 13, 2018

Related U.S. Application Data
(60) Provisional application No. 62/308,373, filed on Mar. 15, 2016.

(51) Int. Cl. F16F 15/00

(52) U.S. Cl. CPC F16F 15/002; G05D 19/02

(57) ABSTRACT

Apparatus and methods to reduce unwanted motion in precision instruments are described. An active vibration-isolation system may be configured to receive a user-selectable setting, sense a stability of operation of the vibration-isolation system, and indicate whether the user-selectable setting provides stable vibration isolation. The settings may be changed by the user to improve vibration-isolation performance without requiring installation of the system by a skilled vibration-isolation engineer.

### BACKGROUND

### Technical Field

The technology relates to an active vibration-isolation system that uses feedback control of actuators to reduce unwanted motion at a supported payload. In some implementations, the supported payload may be a sensitive instrument, such as an optical, atomic-force, or electron-beam microscope.

### Discussion of the Related Art

Precision instruments that are used in various areas of technology (e.g., integrated circuit fabrication, metrology, various areas of microscopy, precision medical instruments etc.) benefit from isolation of ambient sources of noise that can couple unwanted motion (e.g., vibrations, impulses, etc.) into a precision instrument. One approach to vibration isolation is to mount an instrument on a platform that has passive motion dampers (e.g., an air-suspension system with motion-damping components). In some cases, a precision instrument may need vibration isolation from external sources to levels where passive motion dampers do not provide adequate isolation. To achieve such performance, active vibration-isolation systems may be employed between a precision instrument and a base which supports the instrument. For example, an active feedback system may be used to drive actuators to oppose externally-induced motion of the instrument.

### SUMMARY

Apparatus and methods for tuning an active vibration-isolation system to reduce unwanted motion of a precision instrument are described. According to some embodiments, an active vibration-isolation system for reducing motion of an instrument to micron and sub-micron levels may comprise a support structure configured to support the instrument, at least one actuator coupled to the support structure, at least one motion sensor arranged to sense motion of the support structure, and at least one feedback circuit configured to process a signal from the motion sensor(s) and output at least one drive signal to activate the actuator(s) to reduce motion of the support structure. The system may further include at least one stability detector configured to detect a stability of operation of the feedback circuit(s), and a user interface configured to receive an input from a user that alters at least one signal-processing parameter of the feedback circuit(s) and to indicate, based on output from the stability detector(s), whether or not the at least one feedback circuit is in stable operation.

Embodiments also relate to methods of reducing motion of an instrument to micron and sub-micron levels. A method may comprise acts of providing a support structure configured to support the instrument, sensing, with at least one motion sensor, motion of the support structure, processing, with at least one feedback circuit, a signal from the motion sensor(s) to produce at least one drive signal, and applying the drive signal(s) to at least one actuator that is coupled to the support structure to reduce motion of the support structure. A method may further include acts of receiving, at a user interface, an input from a user that identifies a user-selectable vibration-isolation setting, altering at least one signal-processing parameter of the feedback circuit(s) based on the identified user-selectable vibration-isolation setting, sensing, with at least one stability detector, a stability of operation of the feedback circuit(s), and indicating to the user, responsive to the sensed stability, whether or not the at least one feedback circuit is in stable operation.

Some embodiments relate to an active vibration-isolation system for reducing motion of an instrument to micron and sub-micron levels. The system may comprise a support structure configured to support the instrument, a first actuator coupled to the support structure, a first motion sensor arranged to sense motion of the support structure in a first degree of freedom, and a first feedback circuit configured to process a first signal from the first motion sensor and output a first drive signal to activate the first actuator to reduce motion of the support structure in the first degree of freedom. The system may further comprise a stability detector configured to detect a stability of operation of the first feedback circuit, and a user interface configured to receive an input from a user that alters a signal-processing parameter of the first feedback circuit and to indicate, based on output from the stability detector, whether or not the first feedback circuit is in stable operation.

In some aspects, a first user input provided to the user interface alters a gain value for the first feedback circuit. In some cases, the first user input alters the gain value by a factor between 0.6 and 0.75 from a maximum gain setting. In some cases, a second user input alters the gain value by a factor between 0.05 and 0.15 from a maximum gain setting.

According to some implementations, the support structure comprises a payload support, an intermediate mass configured to be supported by offload springs, and support springs connected between the payload support and intermediate mass. In some aspects, the first actuator supports a negligible load compared to the offload springs. In some cases, the first actuator comprises a voice coil actuator. In some implementations, the first motion sensor comprises a geophone.

According to some implementations, the stability detector is configured to evaluate peak deviations of the first signal or processed first signal to determine whether the first feedback circuit is in stable operation. In some cases, the stability detector is configured to evaluate a spectrum of the first signal or processed first signal for the presence of an oscillation peak to determine whether the first feedback circuit is in stable operation.

According to some aspects, an active vibration-isolation system having any of the foregoing features may further comprise a second actuator coupled to the support structure, a second motion sensor arranged to sense motion of the support structure in a second degree of freedom, and a second feedback circuit configured to operate independently of the first feedback circuit and process a second signal from the second motion sensor and output a second drive signal to activate the second actuator to reduce motion of the support structure in the second degree of freedom. The stability detector may be further configured to detect a stability of operation of the second feedback circuit, and the user interface may be further configured to receive an input from the user that alters a signal-processing parameter of the second feedback circuit and to indicate, based on output from the stability detector, whether or not the second feedback circuit is in stable operation.

In some implementations, a single input from the user alters the signal-processing parameter of the first feedback circuit and the signal-processing parameter of the second feedback circuit.

In some implementations, the instrument supported by the support structure is a microscope, a medical instrument, or a microfabrication instrument.

Some embodiments relate to a method of reducing motion of an instrument to micron and sub-micron levels with a vibration-isolation system, an exemplary method comprising acts of providing a support structure configured to support the instrument; sensing, with a first motion sensor, motion of the support structure in a first degree of freedom; processing, with a first feedback circuit, a signal from the first motion sensor to produce a first drive signal; applying the first drive signal to a first actuator that is coupled to the support structure to reduce motion of the support structure in the first degree of freedom; receiving, at a user interface, an input from a user that identifies a user-selectable vibration-isolation setting; altering a signal-processing parameter of the first feedback circuit based on the identified user-selectable vibration-isolation setting; sensing, with a stability detector, a stability of operation of the first feedback circuit; and providing to the user, in response to the sensed stability, an indication of stability of operation of the vibration-isolation system.

A method embodiment may further comprise altering a gain value for the first feedback circuit in response to the input from the user. In some implementations, a method embodiment may further comprise altering the gain value by a factor between 0.6 and 0.75 from a maximum gain setting in response to the input from the user. In some cases, a method embodiment may further comprise altering the gain value by a factor between 0.05 and 0.15 from a maximum gain setting in response to the input from the user.

In some aspects, the support structure comprises a payload support, an intermediate mass configured to be supported by offload springs, and support springs connected between the payload support and intermediate mass. A method embodiment may further comprise supporting a negligible load by the first actuator compared to the offload springs.

In some implementations, a method embodiment may further comprise evaluating, by the stability detector, peak deviations of the first signal or processed first signal to determine whether the first feedback circuit is in stable operation. In some cases, a method embodiment may further comprise evaluating, by the stability detector, a spectrum of the first signal or processed first signal for the presence of an oscillation peak to determine whether the first feedback circuit is in stable operation.

According to some aspects, a method embodiment may further comprise acts of sensing, with a second motion sensor, motion of the support structure in a second degree of freedom; processing, with a second feedback circuit, a signal from the second motion sensor to produce a second drive signal; applying the second drive signal to a second actuator that is coupled to the support structure to reduce motion of the support structure in the second degree of freedom; altering a signal-processing parameter of the second feedback circuit based on the identified user-selectable vibration-isolation setting; sensing, with the stability detector, a stability of operation of the second feedback circuit; and providing to the user the indication of stability of operation of the vibration-isolation system based on sensed stability of the first feedback circuit and the second feedback circuit.

In some cases, a method embodiment may further comprise altering the signal-processing parameter of the first feedback circuit and the signal-processing parameter of the second feedback circuit in response to a single input from the user.

Some implementations may further comprise supporting a microscope, a medical instrument, or a microfabrication instrument with the support structure.

The foregoing summary is provided by way of illustration and is not intended to be limiting. The foregoing apparatus and method embodiments may be implemented with any suitable combination of aspects, features, and acts described above or in further detail below. These and other aspects, embodiments, and features of the present teachings can be more fully understood from the following description in conjunction with the accompanying drawings.

### BRIEF DESCRIPTION OF DRAWINGS

The skilled artisan will understand that the figures, described herein, are for illustration purposes only. It is to be understood that in some instances various aspects of the embodiments may be shown exaggerated or enlarged to facilitate an understanding of the embodiments. In the drawings, like reference characters generally refer to like features, functionally similar and/or structurally similar elements throughout the various figures. The drawings are not necessarily to scale, emphasis instead being placed upon illustrating the principles of the teachings. The drawings are not intended to limit the scope of the present teachings in any way.

FIG. 1 depicts an active vibration-isolation system, according to some embodiments;

FIG. 2 depicts control circuitry for an active vibration-isolation system, according to some embodiments;

FIG. 3A illustrates a signal from a motion sensor that senses natural motion of a support structure, according to some embodiments;

FIG. 3B illustrates a signal from a motion sensor that senses motion of a support structure when active vibration-isolation is employed, according to some embodiments;

FIG. 4 depicts an active vibration-isolation system, according to some embodiments; and

FIG. 5 depicts acts associated with operation of an active vibration-isolation system, according to some embodiments.

Aspects, embodiments, and features of the present teachings can be more fully understood from the following description in conjunction with the accompanying drawings.

### DETAILED DESCRIPTION

The scientific research communities and microfabrication, medical, nanotechnology, optics, and semiconductor industries continue to develop challenging demands for vibration isolation of precision equipment used in research and commercial settings. Vibration isolation typically requires suppression of dynamic forces (typically from external sources) that would otherwise perturb the precision equipment and impair its performance. To obtain proper operation and improved performance of some sensitive instruments, it may be necessary to suppress unwanted motion of an instrument to the sub-micron or even sub-100-nm level.

The inventors have recognized and appreciated that precision instruments can be located in a wide variety of environments where there may be few or multiple sources causing the unwanted motion. Some sources may be external to the precision instrument, and some sources may originate internally to the precision instrument. In some cases, dynamic forces that perturb a precision instrument may be external to the instrument, couple into the instrument (e.g., through a base support, feed lines, and/or acoustic coupling to the equipment), and cause unwanted motion of the instrument.

One approach to providing vibration isolation at sites with widely different noise environments is to employ an active vibration-isolation system. An active vibration-isolation system may include one or more motion sensors and one or more feedback systems. A motion sensor may be arranged to sense motion in at least one degree of freedom of a structure that supports the precision instrument, and the feedback system may be arranged to electromechanically drive the structure to oppose any motion induced by noise sources. Conventionally, such an active vibration-isolation system is tailored to the environment in which it will be located. For example, an engineer may first perform a site visit to characterize the noise environment. Data collected during the site visit may be used during the manufacture of the active vibration-isolation system to tune the system to the noise environment. Additionally or alternatively, a skilled engineer may install the vibration-isolation system at the site and tune the system to operate according to specifications. As the inventors have recognized and appreciated, environment characterization and system tuning by a skilled engineer can significantly increase the cost of ownership of an active vibration-isolation system by thousands of dollars.

The inventors have also recognized and appreciated that the wide variety of noise environments precludes design of an effective, one-size-fits-all, active vibration-isolation system. For example, to accommodate all environments, the vibration-isolation settings on a system must be reduced to an extent that the system no longer provides satisfactory vibration isolation in many, if not most, noise environments. On the other hand, if the settings are increased, then the vibration-isolation system can become unstable in some environments and adversely increase the amount of instrument vibration.

According to some embodiments, an active vibration-isolation system may comprise user-selectable settings, a stability detector, and a stability indicator, so that a user may readily configure the system to improve vibration isolation in a wide variety of noise environments. The addition of user-configurable, vibration-isolation performance of an active vibration-isolation system can eliminate the cost associated with installation of the system by a skilled engineer, and may enable lower-cost vibration-isolation systems to operate with improved performance in different noise environments. In some implementations, an active vibration-isolation system may be configured to automatically adjust its isolation performance to the environment.

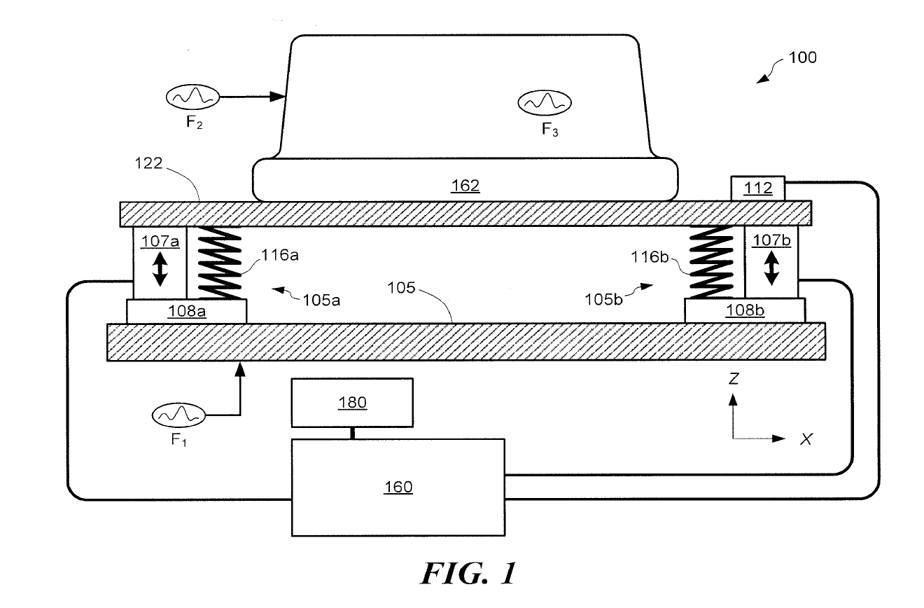

FIG. 1 depicts an active vibration-isolation system 100 that may include apparatus for user-configurable isolation performance, according to some embodiments. An active vibration-isolation system may comprise a support structure 122 that is supported above a base 105 by plural isolation assemblies 105a, 105b. An isolation assembly 105a may comprise an offload springs 116a and/or actuator 107a. According to some implementations, level adjusters 108a, 108b may be included with an isolation assembly to adjust the levelness of the support structure 122. A precision instrument 162 may, in some cases, be mounted directly on the support structure 122. Although only two isolation assemblies 105a, 105b are shown in the drawing, an active vibration-isolation system 100 may include 3 or more isolation assemblies arranged between a support structure 122 and base 105. In some embodiments, there may be isolation assemblies configured to provide vibration isolation in multiple directions, and not only the z direction that is depicted in FIG. 1. For example, isolation assemblies (not shown in FIG. 1) may be included to provide vibration isolation in the x and/or y directions, as well as isolate against perturbations that would otherwise affect pitch, roll, and/or yaw of the precision instrument 162.

The support structure 122 may be formed from any suitable material, such as aluminum, stainless steel, or a combination thereof, though other materials may be used in some embodiments. In some implementations, the offload springs 116a, 116b may carry a majority of the load of the support structure 122 and precision instrument 162, so that the actuators 107a, 107b carry a negligible load compared to the offload springs (e.g., less than ⅛^{th} the load of the offload springs). In this case, the actuators may comprise voice coil actuators (e.g., a linear voice coil motor). In some embodiments, the actuators may comprise piezoelectric stacks that carry a majority of the load, and the offload springs may not be present. A level adjuster 108a, 108b may comprise a threaded drive assembly that is coupled to an actuator 107a, 107b and can be rotated (manually and/or automatically) to adjust a height of an actuator. The base 105 may comprise any suitable material, such as aluminum, stainless steel, or a combination thereof, though other materials may be used. In some implementations, the base 105 may comprise a floor, table or other structure located at a facility, and may not be included as part of a manufactured vibration-isolation system 100. In such implementations, an isolation assembly 105a may be provided as a separately packaged assembly that is configured to mount between the support structure 122 and base 105.

An active vibration-isolation system may further include at least one motion sensor 112, which may be connected to the support structure 122, and electrically connect to control circuitry 160. A motion sensor may comprise an accelerometer or geophone, for example, and may output at least one signal representative of motion in one direction (e.g., the z direction) to control circuitry 160. In multi-axis vibration-isolation systems, one or more motion sensors may output motion signals representative of motion in two or more directions (for example, any combination of x, y, z, pitch, roll, and yaw). Control circuitry 160 may be configured to process signals from the motion sensor(s) 112 and output drive signals to the actuators 107a, 107b that drive the support structure 122 in a manner to oppose motion sensed by the motion sensor. Some examples of feedback control that may be included in control circuitry 160 are described in U.S. Pat. Nos. 5,823,307 and 7,726,452, both of which are incorporated herein by reference. The control circuitry may include passive, active, analog, and/or digital circuit components, and may include processing electronics (e.g., logic components, a microcontroller, a microprocessor, a field-programmable gate array, an application-specific integrated circuit, or some combination thereof).

A user interface 180 may be in communication with the control circuitry 160, according to some embodiments, and may be configured to receive user input and indicate a stability of operation of the vibration-isolation system 100. A user interface may comprise a touch screen, a touch panel, a graphical user interface, mechanical knobs, buttons, toggles, or switches, indicator lights, an imaging display, or some combination thereof.

In a noisy environment, external forces may act on various components of the system depicted in FIG. 1 and would otherwise cause unwanted motion of the precision instrument 162 if the instrument were not vibrationally isolated. For example, external forces F₁ (such a floor vibrations or other mechanical disturbances) might couple to the base 105, and external forces F₂ (such as acoustic noise) might couple directly to the precision instrument 162. In some cases, the precision instrument itself might include sources F₃ of mechanical and/or acoustic noise (for example, motors, actuators, or fans) that can contribute to unwanted vibrational motion of sensitive components of the instrument.

According to some embodiments, unwanted vibrational motion that can disturb the precision instrument 162 may be detected by at least one motion sensor 112 mounted on the support structure 122. One or more signals representative of the unwanted motion may be output by the motion sensor to the control circuitry 160 and processed by electronics in the control circuitry to produce one or more signals that drive the actuators 107a, 107b to reduce the unwanted motion. The sensing of the unwanted motion and producing one or more drive signals comprises an electromechanical feedback loop that suppresses the effects of undesired motion induced by external forces F₁, F₂, F₃.

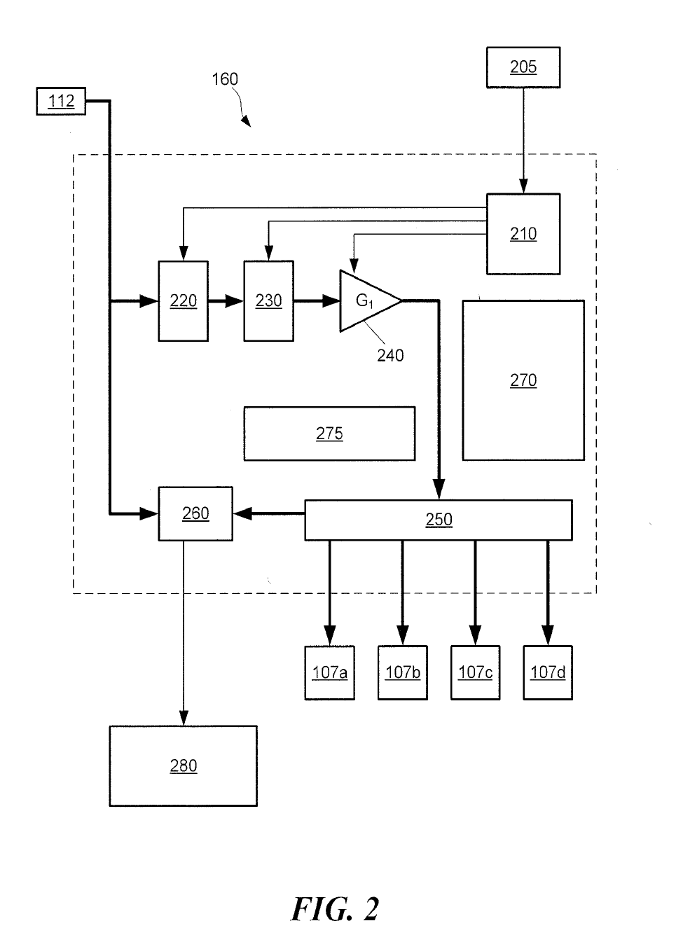

An example of control circuitry 160 is depicted in FIG. 2, though the invention is not limited to only the circuit configuration shown in the drawing. According to some embodiments, control circuitry 160 may include at least one feedback circuit comprising a frequency filter 220, a phase adjuster 230, an amplifier 240, and a signal splitter 250. The frequency filter, phase adjuster, and amplifier may be arranged in a different order than is shown in the drawing, though at least one of these components may receive a signal from a motion sensor 112. Some embodiments may not include a frequency filter and/or phase adjuster. In some cases, frequency filtering and/or phase adjustment functionality may be included in the amplifier 240. Some embodiments may additionally include an integrator (not shown) in the feedback loop that contains the frequency filter, phase adjuster, and amplifier. A parameter associated with an integration time constant for the integrator may be altered by a vibration-isolation setting. The signal splitter 250 may output plural signals to drive plural actuators 107a-107d connected to the support structure 122. In some implementations, a same signal is applied to all actuators for a particular degree of freedom (e.g., applied to four actuators 107a-107d arranged to provide z-directed support to the support structure 122 in FIG. 1). In other cases, a signal may be operated on by a processor 270 or passive components, or each actuator may have its own sensor 112 and feedback circuit, so that different signals are applied to the actuators 107a-107d.

In further detail, the circuitry shown in FIG. 2 may provide vibration-isolation control in a z direction. The motion sensor 112 may be configured on the support structure 122 to sense motion in the z direction. The feedback circuitry may process the sensed z-directed motion and produce a control signal that is sent to the actuators 107a-107d that suppresses unwanted motion in the z direction. Some embodiments may include an additional motion sensor 112, an additional filter 220, additional phase adjuster 230, additional amplifier 240 and at least one additional actuator 107 for each additional degree of freedom (e.g., x, y, pitch, roll, yaw) for which vibration isolation control is desired. Each feedback circuit may operate independently of the other feedback circuits, according to some embodiments.

According to some embodiments, the frequency filter 220 may receive a signal from the motion sensor 112 and may attenuate different spectral components of the received signal by different amounts. In some embodiments, a frequency filter 220 may include plural settable filter parameters that determine amounts of attenuation for different spectral bandwidths operated on by the frequency filter. For example, a filter parameter value may determine an attenuation value for a particular spectral bandwidth. Filter parameter values may be set over a range of frequencies from 0.01 Hz to 30 kHz, according to some embodiments. A frequency filter 220 may be implemented in hardware, software, or a combination thereof.

A phase adjuster 230 may alter the phases of (e.g., add signal delay to) one or more frequency components of a signal received from the motion sensor. In some embodiments, the phase adjuster may include plural settable phase parameters that determine amounts of phase adjustment over different spectral bandwidths. For example, a phase parameter value may determine an amount of signal delay added for a particular spectral bandwidth. A phase adjuster 230 may be implemented in hardware, software, or a combination thereof.

The amplifier 240 may comprise any suitable amplifier that amplifies a signal received from the motion sensor and provides an output signal to drive plural actuators of the active vibration-isolation system 100. According to some embodiments, an amplifier 240 may include one or more settable gain parameters that determine gain values for one or more spectral bandwidths operated on by the amplifier. In some embodiments, the amplifier may have a single settable gain value that is applied over the entire bandwidth of an amplified signal. In some cases, the amplifier 240 may be an inverting amplifier. A gain value for an amplifier 240 may be between 1.5 and 5, according to some embodiments. Different gain values may be used for different degrees of freedom for which vibration is controlled. For example, different gain values may be used for vibration-isolation control in the x, y, and z directions. In some implementations, additional gain may exist within a feedback circuit and the loop gain for a feedback circuit may have a value between 1.5 and 200. In some cases, a gain-settable amplifier 240 may be included to adjust loop gain. An amplifier 240 may be implemented in hardware, software, or a combination thereof. In some implementations, an adjustable attenuator may be included in a feedback loop to adjust loop gain.

Control circuitry 160 may further include a parameter setter 210 that is configured to receive a signal from an input control 205. The input control may comprise a portion of a user interface 180 (e.g., mechanical knob, toggle switch, pushbutton, or item on a graphical user interface), according to some embodiments. A user operating the input control 205 may select one of a plurality of “vibration-isolation” settings provided by the vibration-isolation system. The vibration-isolation settings may be hard-written settings on an instrument panel (e.g., settings such as “LOW”, “MEDIUM”, and “HIGH” written by a mechanical knob or toggle switch), or may be user-selectable, software-displayed settings. The vibration-isolation settings may correspond to different parameter settings of the control circuitry 160 that provide different amounts of vibration isolation.

When a vibration-isolation setting is selected or input by a user via the input control 205, a corresponding control signal may be provided to the parameter setter 210. The parameter setter 210 may receive the control signal, identify one or more parameters associated with the control signal, and output corresponding parameters to one or more components (frequency filter 220, phase adjuster 230, amplifier 240) of the control circuitry 160. In some embodiments, the parameter setter 210 may comprise a look-up table that stores parameter values (e.g., gain settings, filter attenuation values, phase adjustment values) in association with user-selectable, vibration-isolation settings. Responsive to receiving a signal from the input control 205 that identifies a vibration-isolation setting, the parameter setter 210 may identify from the look-up table the corresponding parameter values to the respective components of the control circuitry. For example, responsive to receiving a signal from the input control 205 that identifies a “LOW” vibration-isolation setting, the parameter setter 210 may identify a lowest gain value to the amplifier 240. The amplifier may then use this gain value to process signals received from the motion sensor 112.

In some implementations, an input control 205 and parameter setter 210 may be configured to adjust only gain values for one or more amplifiers 240 connected to one or more actuators 107. For example, there may be four actuators configured to drive a support structure 122 in a z direction, one or more actuators configured to drive the support structure 122 in an x direction, and one or more actuators configured to drive the support structure 122 in an y direction. There may be three amplifiers configured to output signals for the z, x, and y directions. The input control 205 and parameter setter 210 may be configured to output gain values G_{z}, Gₓ, and G_{y}, for a “HIGH” gain setting. In some implementations, the values of G_{z}, Gₓ, and G_{y}, may be between 1.5 and 200, though other values may be used in some cases.

The inventors have found that a broad range of environmental conditions can be adequately cancelled with vibration-isolation apparatus of the present embodiments when the “MEDIUM” gain settings are between 0.6 and 0.75 of the “HIGH” gain settings (e.g., with respect to the full or maximum gain value used) and the “LOW” gain settings are between 0.05 and 0.15 of the “HIGH” gain settings. Other values may be used in some cases. In some embodiments, an open-loop setting may be included in which no feedback signal is applied to the actuators.

According to some embodiments, control circuitry 160 may further include a stability detector 260 that is configured to evaluate the stability of operation of the electromechanical feedback loop and/or evaluate an effectiveness of vibration isolation provided by the electromechanical feedback loop. For example, a stability detector may receive a signal from the motion sensor 112 and determine whether motion is suppressed when the feedback loop is activated, or whether the motion is unchanged or amplified when the feedback loop is activated. In some embodiments, the stability detector may additionally or alternatively receive a signal from the amplifier 240 to evaluate stability of the feedback loop. If the stability detector determines that the motion has been suppressed, the stability detector may output a signal to a stability indicator 280 (e.g., an LED or imaging display on a user interface 180) that indicates to a user that the system is suppressing unwanted vibrational motion. However, if the stability detector 260 determines that vibrational motion has not been suppressed or is amplified, the stability detector may output a signal to the stability indicator 280 to indicate to the user that the system is not isolating vibrations properly.

In some embodiments, control circuitry 160 may also include a processor 270, which may be adapted with machine-language code to execute some or all of the parameter setting, filtering, phase adjustment, amplification, and stability detection functionality. Processor 270 may comprise logic circuitry, a microcontroller, a microprocessor, a digital signal processor, a field-programmable gate array, or some combination thereof. Control circuitry 160 may further include a data storage device 275 (e.g., ROM and/or RAM type memory) that is in communication with the processor 270. The processor may also communicate with the parameter setter 210 and stability detector 260, in some embodiments.

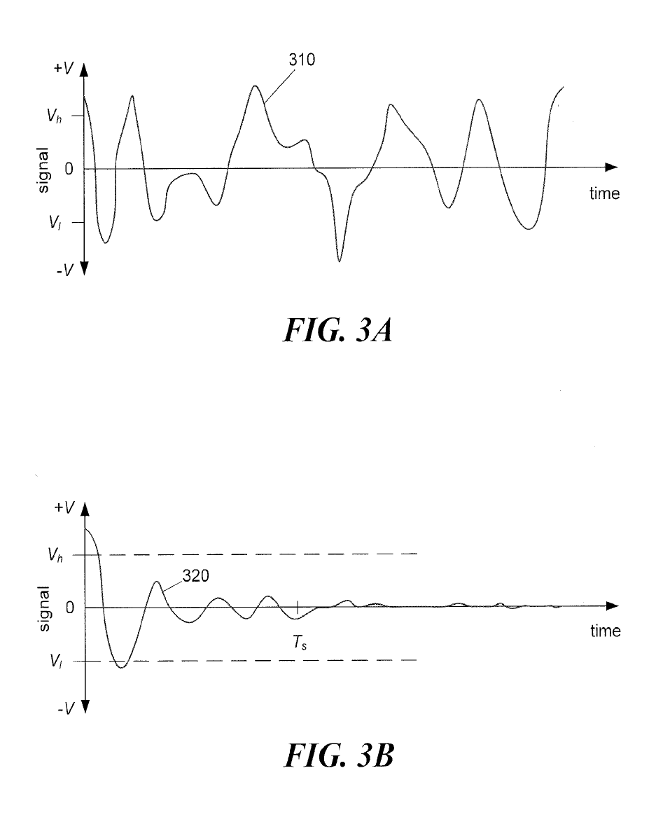

FIG. 3A and FIG. 3B depict an embodiment by which control circuitry 160 may evaluate stability of vibration-isolation operation of an active vibration-isolation system. According to some embodiments, a signal 310 from a motion sensor 112 for a first degree of freedom may be monitored when the system's electromechanical feedback loop for that degree of freedom is not activated (e.g., when an output from the amplifier 240 is not applied to the actuators). The measured signal 310 may indicate a natural motion of the support structure 122 that results from external forces (one or more of F₁, F₂, F₃) acting on the system. According to some embodiments, the control circuitry 160 may process the signal 310 to characterize the natural motion of the system along that degree of freedom.

For example, the control circuitry 160 may process the received signal to detect all positive-going and negative going peaks in the signal 310 over a predetermined period of time. From these values, a characteristic positive displacement (e.g., an average of peak positive displacements) of the support structure 122 from a neutral position may be determined from the signal 310 (e.g., depicted as the signal level Vₕ), and a characteristic negative displacement (e.g., an average of peak negative displacements) may be determined from the signal 310 (e.g., depicted by the signal level Vₗ). These two signal values Vₕ and Vₗ may represent typical bounds of the support structure's natural motion in the environment, though other methods may be used to characterize the natural motion (e.g., maximum displacement, spectral energy, integrated displacement).

When the system's electromechanical feedback loop is activated, the signal from a motion sensor may be processed and the results compared against those obtained for the natural motion. In some embodiments, when the feedback loop is activated, the signal 320 from the motion sensor 112 may exhibit reduced motion as illustrated in FIG. 3B. For example, the averages of peak positive-going and negative-going displacements of the support structure 122 may become significantly less than was the case for the system when the electromechanical feedback loop was not activated, as indicated in the drawing.

In some embodiments, a stability detector 260 may, when the electromechanical feedback loop is activated, repeatedly process the motion sensing signal 320 to compute motion-characterizing values and compare the results against corresponding values computed when the electromechanical feedback loop was not activated to determine a stability and/or effectiveness of vibration-isolation operation of the system. Continuing with the above example, if the computed average peak displacements, when the electromechanical feedback loop is activated, reduce to less than the corresponding natural displacements (Vₕ, Vₗ) within a preselected time (Tₛ), then the stability detector 260 may determine that a feedback circuit for the monitored degree of freedom is in stable operation. When all feedback circuits are in a stable operating state, then the stability detector 260 may determine that the active vibration-isolation system is in a stable operating state. The stability detector 260 may be configured to output a signal to activate a “stable” indicator at the stability indicator 280, so that the user will know that the system is operating properly. Alternatively, if the results from the processed signal 320 indicate that the displacements increase or do not reduce to less than the natural displacements within the preselected time, the stability detector 260 may output a signal to indicate unstable operation of the vibration-isolation system.

In some embodiments, the stability detector 260 may output more than one signal to indicate effectiveness of vibration isolation for the system. For example, the stability detector 260 may output values for one or more feedback circuits that indicate an amount of motion reduction (for example, motion-reduction factors between 1 and 1000 or more or motion-reduction multipliers between 1 and 0.001 or less). The output values may be for each feedback circuit used to vibrationally isolate a degree of freedom of the system, or the output values may be a combined value from feedback circuits for multiple degrees of freedom. The output values may be displayed by the stability indicator 280.

Alternatively or additionally, a spectrum of a signal from a motion sensor 112 or amplifier 240 may be processed to look for an elevated oscillation signal at a particular frequency (e.g., a natural resonance frequency of the system). In some cases, a vibration-isolation feedback system have a gain value that is too high may go into oscillation at a particular frequency. The oscillation may be detected by taking a fast Fourier transform or digital Fourier transform of a signal from a motion sensor 112 or amplifier 240. The oscillation may be detected as a signal at a particular frequency that rises above (by at least 6 dB, for example) a background spectrum that is recorded when no feedback is applied to the system.

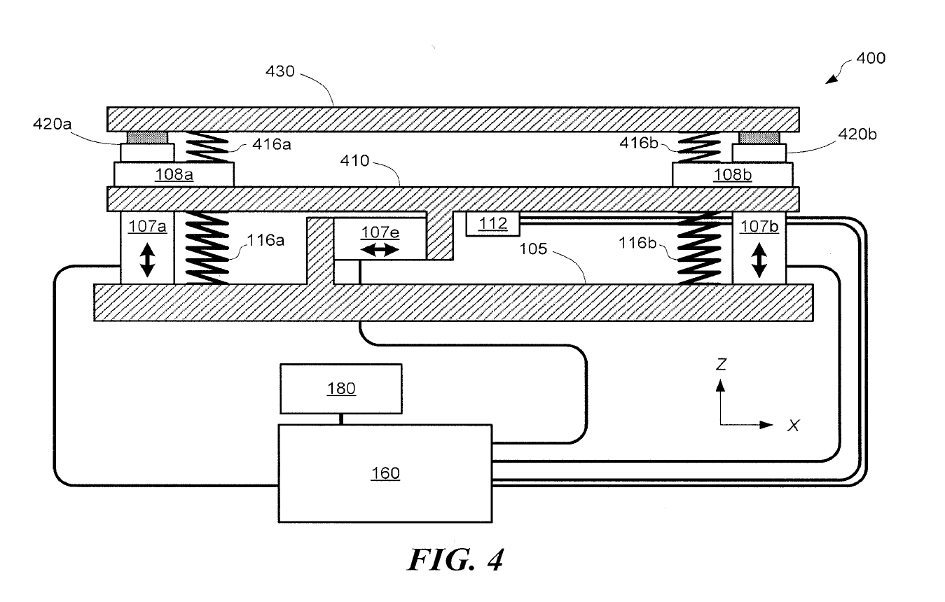

Another example of an active vibration-isolation system 400 which may include user-configurable isolation performance is depicted in FIG. 4. According to some embodiments, a support structure (structure 122 of FIG. 1) may comprise an intermediate mass 410 in an active vibration-isolation system 400. A payload support 430 may be supported over the intermediate mass 410 by additional support springs 416a, 416b. Also, dampers 420a, 420b may be added between the payload support 430 and the intermediate mass 410 to dampen motion of the payload support. In some embodiments, there may be three or more sets of support springs and dampers. Level adjusters 108a, 108b may also be included between the payload support 430 and the intermediate mass 410, according to some implementations. A precision instrument (not shown) may be mounted directly on the payload support 430.

In operation, motion of the intermediate mass 410 may be sensed with at least motion sensor 112, and the actuators 107a, 107b, 107e may be driven to suppress motion of the intermediate mass. For example, a first motion sensor 112 may sense motion in the z direction and a second motion sensor (not visible) may sense motion in the x direction. In some cases, a third motion sensor (not shown) may sense motion in the y direction. Output from the first motion sensor 112 may be provided to a first feedback circuit in control circuitry 160 that drives a plurality of actuators 107a, 107b acting on the intermediate mass 410 in the z direction. An output from the second motion sensor may be provided to a second feedback circuit in control circuitry 160 that drives an actuators 107e acting on the intermediate mass 410 in the x direction. The first feedback circuit may operate independently of the second feedback circuit, according to some embodiments. The control circuitry 160 may be configured as was described for the vibration-isolation system of FIG. 1. The system of FIG. 4 may provide an additional level of vibration isolation to a precision instrument by providing a substantially motionless intermediate mass 410 and by providing further vibration-isolation components (support springs 416 and dampers 420) between the near-motionless intermediate mass 410 and payload support 430 on which a precision instrument may be mounted.

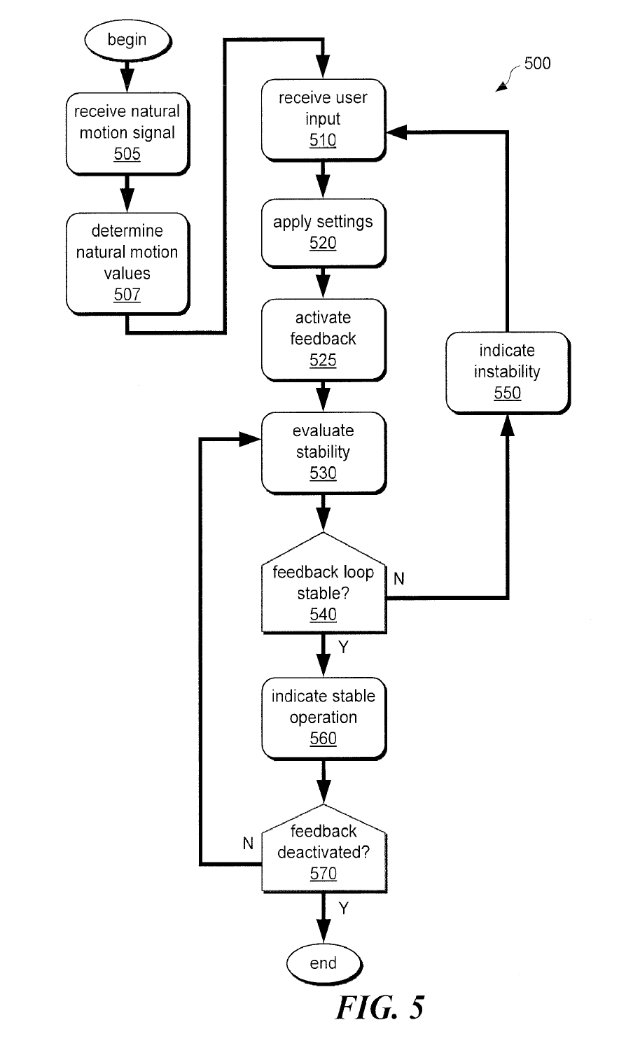

Acts associated with a method 500 of operating an active vibration-isolation system are depicted in FIG. 5, according to some embodiments. After a vibration-isolation system has been powered up, control circuitry 160 may deactivate the system's electromechanical feedback loop and receive (act 505), from a motion sensor 112, a motion signal representative of natural motion of the system's support structure 122. The control circuitry may process the received signal and determine (act 507) one or more values that characterize the natural motion.

In some implementations, the control circuitry 160 may receive (act 510) user input that identifies a selected vibration-isolation setting for the system. The control circuitry 160 may apply (act 520) one or more parameter settings to components of the system's electromechanical feedback loop in the active vibration-isolation system. The system may then activate (act 525) the feedback loop to vibrationally isolate the support structure 122. The stability detector 260 may evaluate (act 530) stability of the feedback loop and determine (act 540) whether the electromechanical feedback loop is operating stably. If the feedback loop is not operating stably, the stability detector may provide a signal to the stability indicator 280 to indicate (act 550) an instability of operation of the vibration-isolation system. In some implementations, instability may be indicated by not activating a “stable” indicator. The system may subsequently receive (act 510) new user input changing a vibration-isolation setting, and repeat acts 520-540.

If the stability detector 260 determines (act 540) that the feedback loop is operating stably, the stability detector may output a signal to indicate (act 560) stable vibration-isolation operation. The control circuitry 160 may then operate normally until it determines (act 570) that the feedback loop has been deactivated (e.g., the feedback loop may be deactivated when the system is powered down and the routine may end). If the feedback loop is not deactivated, the stability detector 260 may continue to evaluate (act 530) stability of operation and repeat acts 540-570.

In some embodiments, any time after determining (act 540) that the feedback loop is operating stably, a processor 270 may store vibration-isolation parameter settings in memory 275. Upon subsequent start-up (e.g., before receiving (act 510) user input), the system may load the stored vibration-isolation parameter settings from memory and execute acts 520-570.

According to some embodiments, a user operating the vibration-isolation system may, during a set-up routine, cycle through user-selectable, vibration-isolation settings to determine a best setting for the noise environment in which the system is located. For example, the user may increase the vibration-isolation setting until the system indicates unstable operation, and then reduce the vibration-isolation setting to a last setting that indicated stable operation.

In some embodiments, the selection of a vibration-isolation setting may be determined automatically by the control circuitry 160 of the vibration-isolation system. For example, the control circuitry 160 may be configured to automatically cycle through each vibration-isolation setting and evaluate stability for each setting. The settings may be increased automatically until the system operation becomes unstable (e.g., the stability detector 260 outputs a signal indicating unstable operation). Once an unstable setting has been identified, the control circuitry may automatically return the vibration-isolation setting to the previous setting for which stable operation was identified.

Although the descriptions for the systems shown in FIG. 1 and FIG. 4 refer to a single motion sensor 112, there may be additional motion sensors in some embodiments that are used to assess vibration-isolation stability and to generate control signals to the actuators. For example, a system may include additional motion sensors on the base 105, the payload support 430, and/or the precision instrument 162. Signals from an additional motion sensor may be provided to an additional feedback circuit or feedforward circuit and applied to one or more actuators. The additional feedback circuit or feedforward circuit may operate independently of other feedback and feedforward circuits.

Some vibration-isolation systems that employ user-selectable vibration-isolation settings may implement dynamically-adaptive vibration-isolation functions. In such embodiments, the user-selectable settings may alter values (e.g., coefficients) of the adaptive vibration-isolation functions. Referring to FIG. 2 again, one or more of the parameters associated with the frequency filter 220, phase adjuster 230, amplifier 240, and integrator (not shown) may dynamically vary, during operation of the system, in dependence on one or more quantities calculated from the signal (or signals) received from the motion sensor 112 (and/or other motion sensors mounted at other locations in the system). Adaptive vibration-isolation functions may be useful for instruments operating at sites where there are regular changes in the environmental noise sources. Adaptive vibration-isolation functions may also provide finer tuning of vibration-isolation performance to an environment than discreet user-selectable settings.

By way of further explanation, an example of a vibration-isolation system that employs an adaptive vibration-isolation function is a system in which a gain setting for the amplifier 240 may be dependent upon a noise energy or noise power in the environment. The noise power may be sensed by a motion sensor 112 or other sensor of the system. For example, the amplifier's operating gain G may be determined from the following expression

G(t)=Gₒ+kPₙ

where Gₒ is a baseline gain value, Pₙ is a time-averaged noise power that is sensed by a motion sensor over a measurement interval, and k is a proportionality constant. Since Pₙ may vary in time, the resulting gain value G is dynamic and varies in time. According to some implementations, a user-selectable setting may alter one or both of the baseline gain value Gₒ and the proportionality constant k. In this way, adaptive vibration-isolation functions may be altered via user-selectable settings.

The inventors have recognized and appreciated that an active vibration-isolation system is capable of suppressing unwanted motion of an instrument to the micron and sub-micron level when properly installed and tuned by a skilled vibration-isolation engineer. The inventors have found that low-cost active vibration-isolation systems that employ user-selectable vibration-isolation settings according to the embodiments described herein are also capable of suppressing unwanted motion of an instrument to the micron and sub-micron level when installed and adjusted by a customer.

The technology described herein may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Additionally, a method may include more acts than those illustrated, in some embodiments, and fewer acts than those illustrated in other embodiments.

Having thus described at least one illustrative embodiment of the invention, various alterations, modifications, and improvements will readily occur to those skilled in the art. Such alterations, modifications, and improvements are intended to be within the spirit and scope of the invention. Accordingly, the foregoing description is by way of example only and is not intended as limiting.

1. An active vibration-isolation system for reducing motion of an instrument to micron and sub-micron levels, the system comprising:
a support structure configured to support the instrument;
a first actuator coupled to the support structure;
a first motion sensor arranged to sense motion of the support structure in a first degree of freedom;
a first feedback circuit configured to process a first signal from the first motion sensor and output a first drive signal to activate the first actuator to reduce motion of the support structure in the first degree of freedom;
a stability detector configured to detect a stability of operation of the first feedback circuit; and
a user interface configured to receive an input from a user that alters a signal-processing parameter of the first feedback circuit and to indicate, based on output from the stability detector, whether or not the first feedback circuit is in stable operation.

2. The active vibration-isolation system of claim 1, wherein a first user input alters a gain value for the first feedback circuit.

3. The active vibration-isolation system of claim 2, wherein the first user input alters the gain value by a factor between 0.6 and 0.75 from a maximum gain setting.

4. The active vibration-isolation system of claim 3, wherein a second user input alters the gain value by a factor between 0.05 and 0.15 from a maximum gain setting.

5. The active vibration-isolation system of claim 1, wherein the support structure comprises:
a payload support;
an intermediate mass configured to be supported by offload springs; and
support springs connected between the payload support and intermediate mass.

6. The active vibration-isolation system of claim 5, wherein the first actuator supports a negligible load compared to the offload springs.

7. The active vibration-isolation system of claim 5, wherein the first actuator comprises a voice coil actuator.

8. The active vibration-isolation system of claim 1, wherein the first motion sensor comprises a geophone.

9. The active vibration-isolation system of claim 1, wherein the stability detector is configured to evaluate peak deviations of the first signal or processed first signal to determine whether the first feedback circuit is in stable operation.

10. The active vibration-isolation system of claim 1, wherein the stability detector is configured to evaluate a spectrum of the first signal or processed first signal for the presence of an oscillation peak to determine whether the first feedback circuit is in stable operation.

11. The active vibration-isolation system of claim 1, further comprising:
a second actuator coupled to the support structure;
a second motion sensor arranged to sense motion of the support structure in a second degree of freedom; and
a second feedback circuit configured to operate independently of the first feedback circuit and process a second signal from the second motion sensor and output a second drive signal to activate the second actuator to reduce motion of the support structure in the second degree of freedom, wherein
the stability detector is further configured to detect a stability of operation of the second feedback circuit, and
the user interface is further configured to receive an input from the user that alters a signal-processing parameter of the second feedback circuit and to indicate, based on output from the stability detector, whether or not the second feedback circuit is in stable operation.

12. The active vibration-isolation system of claim 11, wherein a single input from the user alters the signal-processing parameter of the first feedback circuit and the signal-processing parameter of the second feedback circuit.

13. The active vibration-isolation system of claim 1, wherein the instrument is a microscope, a medical instrument, or a microfabrication instrument.

14. A method of reducing motion of an instrument to micron and sub-micron levels with a vibration-isolation system, the method comprising:
providing a support structure configured to support the instrument;
sensing, with a first motion sensor, motion of the support structure in a first degree of freedom;
processing, with a first feedback circuit, a signal from the first motion sensor to produce a first drive signal;
applying the first drive signal to a first actuator that is coupled to the support structure to reduce motion of the support structure in the first degree of freedom;
receiving, at a user interface, an input from a user that identifies a user-selectable vibration-isolation setting;
altering a signal-processing parameter of the first feedback circuit based on the identified user-selectable vibration-isolation setting;
sensing, with a stability detector, a stability of operation of the first feedback circuit; and
providing to the user, in response to the sensed stability, an indication of stability of operation of the vibration-isolation system.

15. The method of claim 14, further comprising altering a gain value for the first feedback circuit in response to the input from the user.

16. The method of claim 15, further comprising altering the gain value by a factor between 0.6 and 0.75 from a maximum gain setting in response to the input from the user.

17. The method of claim 15, further comprising altering the gain value by a factor between 0.05 and 0.15 from a maximum gain setting in response to the input from the user.

18. The method of claim 14, wherein the support structure comprises:
a payload support;
an intermediate mass configured to be supported by offload springs; and
support springs connected between the payload support and intermediate mass.

19. The method of claim 18, further comprising supporting a negligible load by the first actuator compared to the offload springs.

20. The method of claim 14, further comprising evaluating, by the stability detector, peak deviations of the first signal or processed first signal to determine whether the first feedback circuit is in stable operation.

21. The method of claim 14, further comprising evaluating, by the stability detector, a spectrum of the first signal or processed first signal for the presence of an oscillation peak to determine whether the first feedback circuit is in stable operation.

22. The method of claim 14, further comprising:
sensing, with a second motion sensor, motion of the support structure in a second degree of freedom;
processing, with a second feedback circuit, a signal from the second motion sensor to produce a second drive signal;
applying the second drive signal to a second actuator that is coupled to the support structure to reduce motion of the support structure in the second degree of freedom;
altering a signal-processing parameter of the second feedback circuit based on the identified user-selectable vibration-isolation setting;
sensing, with the stability detector, a stability of operation of the second feedback circuit; and
providing to the user the indication of stability of operation of the vibration-isolation system based on sensed stability of the first feedback circuit and the second feedback circuit.

23. The method of claim 18, further comprising altering the signal-processing parameter of the first feedback circuit and the signal-processing parameter of the second feedback circuit in response to a single input from the user.

24. The method of claim 14, further comprising supporting a microscope, a medical instrument, or a microfabrication instrument with the support structure.
